(19) United States
(12) Patent Application Publication
(10) Pub. No.: US 2002/0007333 A1
(43) Pub. Date: Jan. 17, 2002

(54) Contract bidding for custom synthesis of a chemical structure

(76) Inventors: Pablo A. Scolnik, Chapel Hill, NC (US); Gary M. Eichenbaum, Durham, NC (US)

Correspondence Address: PENNIE & EDMONDS LLP, 1667 K STREET NW, SUITE 1000, WASHINGTON, DC, 20006

(21) Appl. No.: 09/773,563

(22) Filed: Feb. 2, 2001

Related U.S. Application Data
(60) Provisional application No. 60/179,727, filed on Feb. 2, 2000.

(51) Int. Cl. G06F 17/60

(52) U.S. Cl. 705/37; 705/26

(57) ABSTRACT

The present invention relates to a system and method for managing contract bidding of chemical synthesis on a communications or computer network. The system processes requests for proposals for synthesis of a chemical structure, weights synthesis factors supplied by a customer, and identifies potential suppliers. The system distributes the requests for proposals and solicits bids on each request for proposals, and then identifies appropriate, qualified suppliers for the synthesis.

### CROSS-REFERENCE TO RELATED APPLICATIONS

The benefit of provisional application Ser. No. 60/179,727 filed Feb. 2, 2000 is claimed under 35 U.S.C. § 119(e).

### FIELD OF THE INVENTION

The present invention relates to a system and method for managing contract bidding for custom synthesis of a chemical structure. More particularly, the invention is related to a system for qualifying potential suppliers using an algorithm that scores suppliers on numerous factors, selects eligible contractors and issues a request for bids, and then provides a list of best-fit bids to the service requester based on an evaluation by the system of all returned bids. A reaction database may also be queried in order to provide one or more chemical synthesis strategies. Databases containing bibliographic or experimental information, or data derived from simulations or other computational approaches, may also be integrated with the system, as may input provided by one or more experts.

### BACKGROUND OF THE INVENTION

The rapid expansion and acceptance of the internet, or world wide web, as a means for facilitating electronic commerce has provided new opportunities for industries that supply information-related services. In particular, the collection, modification, and dissemination of information can now be accomplished in an automated, organized fashion using, for example, client-server concepts and technologies. Web-based applications can allow a customer to submit a request for a product to an intermediary, with the intermediary controlling the collection, solicitation, and dissemination of information to potential suppliers.

Worldwide, the fine and specialty chemicals industry is a multi-billion dollar market, but the industry faces the challenge of matching buyers of a particular chemical with sellers that have inventory of the chemical or the capability to readily produce the chemical. Typically, a buyer may only possess basic information about the chemical, such as a trade name. More detailed information, such as a Chemical Abstract Service CAS Registry Numbers®, facilitates a search for suppliers. Furthermore, if some variation from the desired chemical is permissible, various directories of suppliers of chemicals are available for this purpose. A search in such directories might proceed by searching under particular functional groups or R-groups, moieties, or the base structure of the chemical. However, these directories do not assist with the identification of potential suppliers of custom chemical synthesis services, nor do they allow for an integrated approach for soliciting bids for custom chemical synthesis. These directories do not assist in the development of chemical synthesis strategies, and thus the directories have only limited application.

Bidding systems already exist that try to match commercially available chemicals in bulk quantities to customers at a mutually agreed upon price. However, no business-to-business e-commerce system exists for effectuating computerized bidding by eligible suppliers on structures of chemicals that do not exist in the marketplace and thus require custom synthesis. In addition, for chemicals that are commercially available, there is no business-to-business e-commerce system by which a customer can try to contract to make that chemical by a customized approach, for example by using a particular synthesis strategy.

There also is no bidding system that allows groups of customers or buyers to pool their individual interests in the custom synthesis of a chemical, or the pooling of interests in the generation of synthesis strategies that may be explored by a supplier.

Interconnected computer networks such as the internet provide a means for building the complex, transaction-based applications that are distributed over several networked computers, and allow e-commerce to be developed. Essentially, a software application program, executing on a client, initiates a transaction that requires access to services provided by a distant computer, the server. In a typical scenario, the client submits a “request” message to the server, and the server responds with a “response” message in regard to the request.

The server is not limited to one computer, but instead may be an assemblage of interconnected heterogenous computers. In such a case, any request message must be written in such a manner that all interconnected computers can interpret and respond to it. In some configurations, the assemblage of interconnected computers operates in an object-oriented programming model. These configurations allow one or more software objects, which may work in concert to provide a response to the request message, to be distributed among the interconnected computers. Additional, detailed background information on this object-oriented approach can be found, for example, in Client/Server Programming with Java and CORBA, 2^{nd} ed., Robert Orfali and Dan Harkey, John Wiley & Sons, Inc., 1998, relevant portions of which are incorporated herein by reference.

There is a need for a system and method for effectuating bilateral business-to-business commerce for custom chemicals through a central controller. Furthermore, there is a need for a system and method that employs an algorithm for evaluating a set of contracting or synthesis criteria provided by a customer, and matching the customer with a supplier. This is facilitated with a bidding system managed by a computer. There is further a need for a system and method that can provide customized strategies for making the desired compound or suggest the synthetic strategies themselves, and solicit bids from eligible suppliers based on particular synthesis steps.

Thus, there is a need for a system and method that enable a customer to be matched with a supplier. More particularly, there is a need for a system and method for matching a customer requiring synthesis of a particular chemical structure with a supplier capable of furnishing the chemical structure. Specifically, there is a need for such a method and system that qualifies potential suppliers using an algorithm that scores suppliers on factors relevant to the buyer such as cost, quality, and timing of delivery. Such a system is needed to facilitate and accelerate the process of custom chemical synthesis, especially but not limited to the area of drug discovery.

### SUMMARY OF THE INVENTION

The present invention relates to a method for managing contract bidding of chemical synthesis on a computer network, the method including the steps of: receiving a customer's request for quotation for synthesis of a chemical structure; evaluating potential suppliers based upon at least one factor provided by the customer; identifying eligible suppliers for bidding on the synthesis; releasing the request for quotation to eligible suppliers; receiving bids from eligible suppliers; evaluating the bids and providing the customer with a list of qualified suppliers; and receiving a customer's choice of qualified supplier for the synthesis.

In one embodiment, the chemical structure may be a family of compounds, and the at least one factor may be selected from delivery timing, cost, product yield, level of confidentiality, level of quality control, purity, stereochemical requirements, and synthesis reaction steps. The synthesis reaction steps may include at least one synthesis route, and the synthesis route may be determined with at least one route factor selected from yield percent, number of steps to commercially available starting materials, number of purification steps, and cost per unit mass of product. The list of qualified suppliers may be generated by weighting the at least one factor and obtaining a best fit to sets of qualifications of the potential suppliers. The sets of qualifications of the potential suppliers may include at least one of delivery timing, cost, product yield, level of confidentiality, level of quality control, purity, stereochemical requirements, and synthesis reaction steps. The releasing step may occur over the internet, and the method may further include the step of establishing a binding contract between the customer and the customer's choice of qualified supplier.

The present invention is also related to a computerized system for managing contract bidding of chemical synthesis on a communications or computer network, with the system including means for processing requests for proposals for synthesis of a chemical structure, means for weighting synthesis factors supplied by a customer, means for identifying potential suppliers, means for distributing the requests for proposals and soliciting bids on each request for proposals, and means for identifying appropriate suppliers for the synthesis.

### BRIEF DESCRIPTION OF THE DRAWINGS

Preferred features of the present invention are disclosed in the accompanying drawings, wherein similar reference characters denote similar elements throughout the several views, and wherein:

FIG. 1 is a computer-based system of the present invention using the Internet as the communication network;

FIG. 2 is a block diagram of a typical computer useful with the present development;

FIG. 3 is a flow chart of the steps in the method according to the present invention;

FIG. 4 is a flow chart of the steps in another method according to the present invention;

FIG. 5 is a flow chart of the steps in yet another method according to the present invention; and

FIG. 6 is a flow chart of the steps in yet another method according to the present invention.

FIGS. 7-12 provide illustrations of sample screens displayed on computer terminals according to the method of the present invention.

### DETAILED DESCRIPTION OF THE PREFERRED EMBODIMENTS

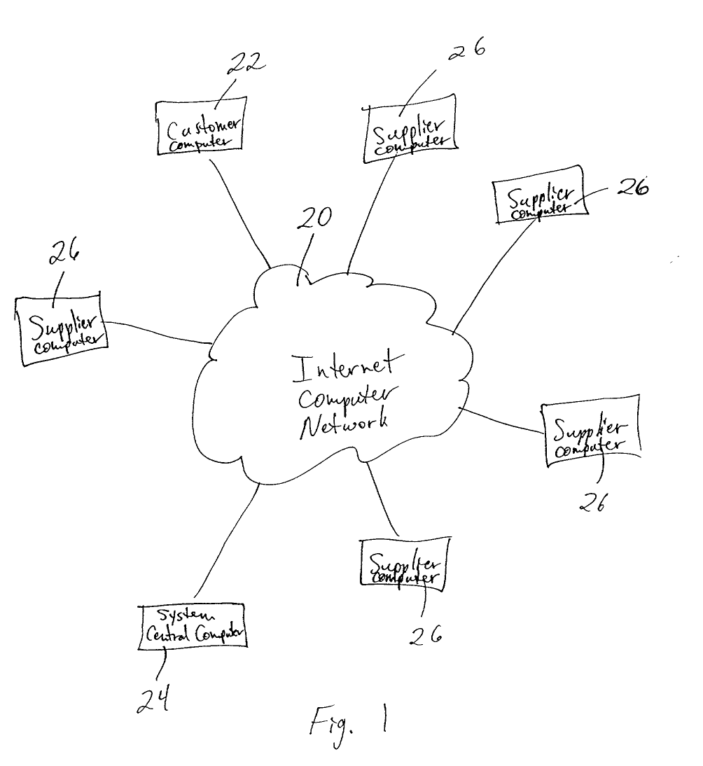

The present invention is directed to a computerized system forming a communications network for managing contract bidding for custom synthesis of a chemical structure. FIG. 1 shows a first embodiment of the system, wherein the internet is employed as the computer communication network 20. Customer computer 22 is connected via the internet to intermediary system central computer 24. Supplier computers 26 are also connected via the internet to the intermediary system central computer 24, which manages the dispersal, collection, and processing of information to, from, and between customer computer 22 and supplier computers 26. Preferably, computers 22, 24, and 26 are personal computers, and are connected to the internet through an Internet Service Provider. Each computer 22, 24, and 26 may be provided with web-browsing software, which is used to facilitate information exchange and display. Alternatively, conventional communications systems such as voice telephony may be employed.

Thus, as seen in FIG. 1, one or more computers are linked together by a computer network exemplified in a network 20. The network can include a server, router or the like, and additional computers that permit data, instructions and/or messages to be passed among the networked computers. Mass storage devices may be connected to the server, or to any of the computers, and some of the computers may include an independent network connection between them. The design, construction, and implementation of a computer network suitable for the present invention may be achieved in a multitude of approaches, as known in the art.

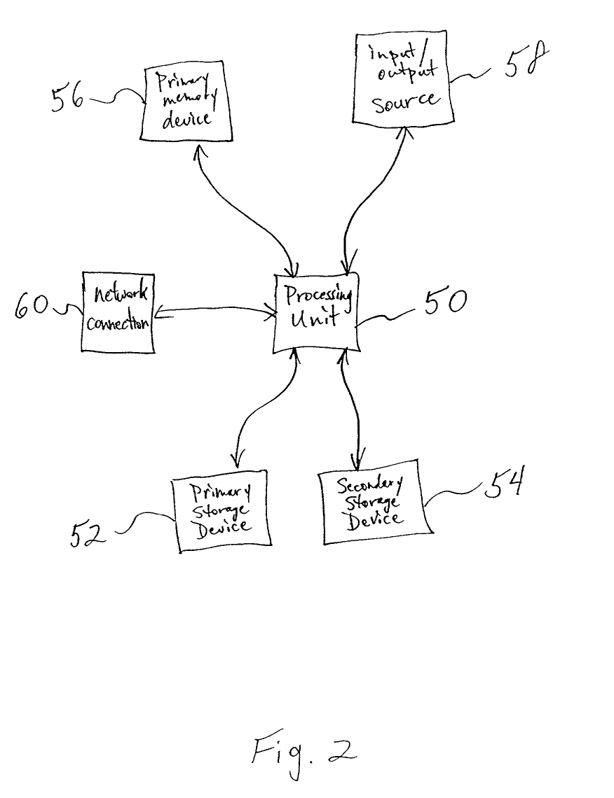

As shown in FIG. 2, each computer typically includes a processing unit 50 such as a central processing unit, or CPU. Parallel processing may also be employed, such as with multiple or distributed processors. A primary storage device 52 and a secondary storage device 54 are also included, along with a primary memory device 56. Device 56 includes random access memory (RAM) that stores programming instructions and data for processes operating on the processing unit 50. Device 56 also includes read only memory (ROM), that stores basic operating instructions, data and objects used by the computer to perform its functions.

The secondary storage device 54 may be, for example, a hard disk, CD ROM, magneto-optical (optical) drive, tape drive or other suitable storage device, and is typically coupled to the processing unit 50.

Each computer may also include an input/output source 58, which is often chosen as a keyboard, mouse, stylus, or other suitable device. Furthermore, a network connection 60 may be provided with each computer. Those skilled in the art will also contemplate other configurations of the computers and associated technology, which are readily usable with the present development.

Regarding the computer networks employed in the present development, these networks include a set of communications channels interconnecting a set of computer systems that can communicate with each other. Among the many communications channels suitable for use with the present development are common transmission media such as twisted pair wires, coaxial cable, optical fibers, satellite links, and/or digital microwave radio. However, the present development need not be implemented solely with the aforementioned types of communication channels. Distributed computing systems over wide area networks are contemplated, although local area networks may also be appropriate for some configurations of the present development. The wide-area and local-area networks may be combined in use, most appropriately in the form of the internet. The internet is contemplated to provide a primary means upon which to fashion the present development, although other communication systems as known to those skilled in the art may instead be employed.

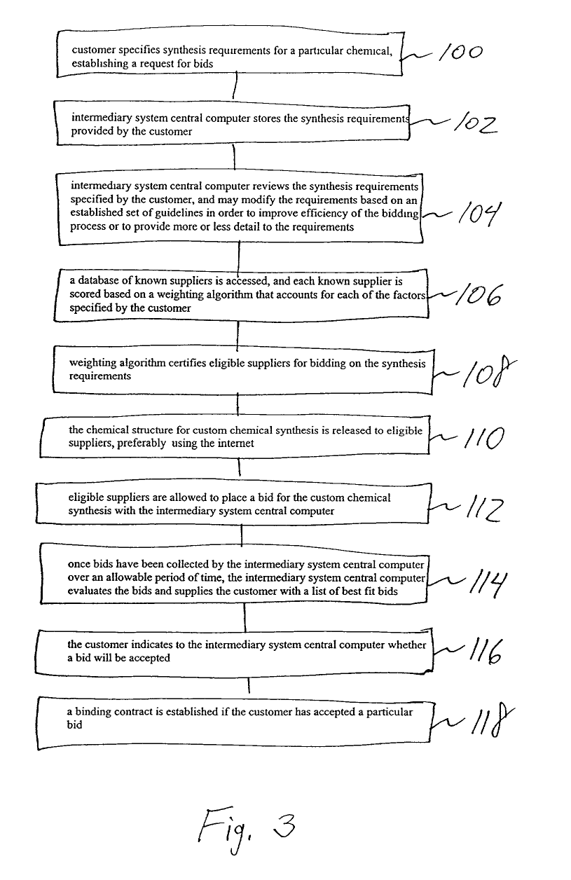

FIG. 3 shows a flow chart of the preferred embodiment of the present invention. During intial step 100, a customer specifies a set of synthesis requirements for a particular chemical, establishing a request for bids. The synthesis requirements may include a variety of factors that are to be considered in the bidding process for the custom chemical synthesis. Factors of importance to the customer may include the chemical structure of the desired product, the desired timing of delivery of the product, an acceptable cost for the product. Another factor may include the desired product yield, as the customer may be insensitive to the efficiency of the chemistry producing the product. Additionally, the customer may specify a desired level of confidentiality during the bidding process. This factor may account for the level of trust and industry reputation of potential contractors, and thus serves to limit the pool of potential contractors that will receive specifications for the custom chemical synthesis and be allowed to bid. For example, if the customer requires a high level of confidentiality, only a select group of suppliers will be given access to the request for bids. If the customer only requires a relatively low level of confidentiality, the chemical structure will be made available to a broad range of contractors. The customer may also specify the desired level of quality control required in order to assure receipt of a chemical with a desired level of purity. Stereochemical requirements, and required synthetic reaction steps for making the product may also be specified. Thus, each factor is weighted, or prioritized, by the customer.

In step 102, the intermediary system central computer stores the synthesis requirements provided by the customer. Next, in step 104, the intermediary system central computer reviews the synthesis requirements specified by the customer, and may modify the requirements based on an established set of guidelines in order to improve efficiency of the bidding process or to provide more or less detail to the requirements. During step 106, a database of known suppliers is accessed, and each known supplier is scored based on a weighting algorithm that accounts for each of the factors specified by the customer. The weighting algorithm next certifies eligible suppliers for bidding on the synthesis requirements in step 108. Preferably, the chemical structure for custom chemical synthesis is released to eligible suppliers in step 110 using the internet. Eligible suppliers are then allowed to place a bid for the custom chemical synthesis with the intermediary system central computer in step 112. Once bids have been collected by the intermediary system central computer over an allowable period of time, the intermediary system central computer evaluates the bids and supplies the customer with a list of best fit bids in step 114. These best fit bids may be determined based on a set of additional criteria such as the intermediary's past experiences (for example, the track record) with the supplier, specialized knowledge or capabilities of the supplier, geographic location of the supplier, or other considerations. The best fit bids thus become a means for identifying appropriate, qualified suppliers for the synthesis. Finally, in step 116, the customer indicates to the intermediary system central computer whether a bid will be accepted. In step 118, a binding contract is established if the customer has accepted a particular bid. Alternatively, the intermediary system central computer may release the name of the chosen supplier to the customer, and the name of the customer to the chosen supplier. Preferably, the intermediary system monitors compliance of suppliers and customers with the execution of the binding contract, and also monitors progress of the custom chemical synthesis from the time the supplier is engaged by the customer through delivery and acceptance of the chemical.

In a second embodiment, a chemical reaction database is used by either the customer or the intermediary system central computer to first identify compound synthesis strategies. The customer or intermediary system central computer then selects any precursors or targets to be subjected to bidding, and the intermediary system central computer may supplement the customer's requirements with additional synthesis requirements such as particular reaction steps to be used. Alternatively, the intermediary system central computer may screen the suggested synthesis strategies and improve them based on an improvement algorithm.

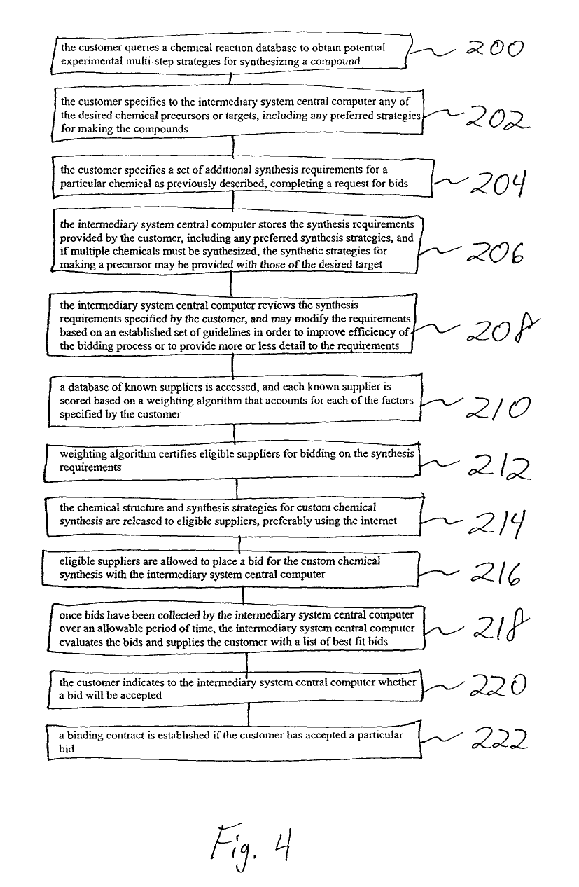

In a third embodiment shown in FIG. 4, the chemical contracting process is seamlessly linked to a chemical synthesis strategy that is derived from a chemical reaction database. In step 200, the customer initially queries the chemical reaction database to obtain potential experimental multi-step strategies for synthesizing a compound. In step 202, the customer next specifies to the intermediary system central computer any of the desired chemical precursors or targets, including any preferred strategies for making the compounds. During step 204, a customer specifies a set of additional synthesis requirements for a particular chemical as previously described, completing a request for bids.

In step 206, the intermediary system central computer stores the synthesis requirements provided by the customer, including any preferred synthesis strategies. If multiple chemicals must be synthesized, the synthetic strategies for making a precursor may be provided with those of the desired target. Next, in step 208, the intermediary system central computer reviews the synthesis requirements specified by the customer, and may modify the requirements based on an established set of guidelines in order to improve efficiency of the bidding process or to provide more or less detail to the requirements. During step 210, a database of known suppliers is accessed, and each known supplier is scored based on a weighting algorithm that accounts for each of the factors specified by the customer. The weighting algorithm next certifies eligible suppliers for bidding on the synthesis requirements in step 212. Preferably, the chemical structure and synthesis strategies for custom chemical synthesis are released to eligible suppliers in step 214 using the internet. Eligible suppliers are then allowed to place a bid for the custom chemical synthesis with the intermediary system central computer in step 216. Once bids have been collected by the intermediary system central computer over an allowable period of time, the intermediary system central computer evaluates the bids and supplies the customer with a list of best fit bids in step 218. Again, as described above, the best fit bids become a means for identifying appropriate, qualified suppliers for the synthesis. Finally, in step 220, the customer indicates to the intermediary system central computer whether a bid will be accepted. In step 222, a binding contract is established if the customer has accepted a particular bid. Alternatively, the intermediary system central computer may release the name of the chosen supplier to the customer, and the name of the customer to the chosen supplier.

A significant cost and time advantage is gained by linking the system to a synthesis planning tool in the form of an experimental database because this reaction information, which is traditionally required by custom suppliers, can be very costly to generate and validate. Preferably, the reaction database is either bibliographic or generated by the intermediary system central computer. Alternatively, multiple databases may be integrated by the intermediary system central computer, with the databases being either bibliographic or experimental. Databases containing data derived from simulations or other computational approaches may also be integrated, as may input provided by one or more experts.

In a fourth embodiment of the present invention, the synthesis strategy is identified and validated by the intermediary system central computer, and included as part of the request for bids that is released to eligible suppliers.

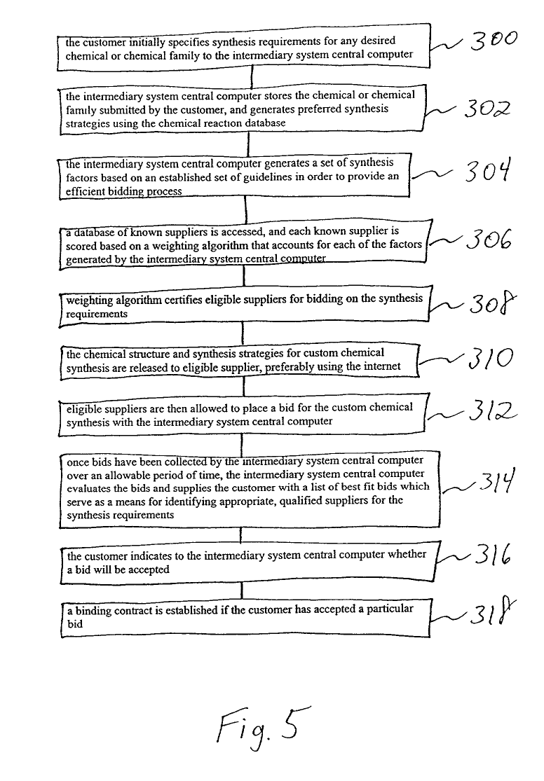

Referring to FIG. 5, a flow chart is shown, indicating another preferred embodiment of the present invention. In this embodiment, the system only requires that a customer specify a chemical structure. No other specifications need be provided by the customer. The intermediary system central computer generates possible synthesis routes without any additional input from the customer. For example, a customer may have a reasonable suspicion that a particular compound or family of compounds might be biologically active. In this case, the customer could use the intermediary system central computer to determine synthesis strategies, and furthermore to provide options for outsourcing production of the compound or family of compounds. A customer might be interested in a particular family, such as benzodiazepines, for example. In this situation, the customer would only need to supply the name of this general chemical family to the intermediary system central computer, which would then identify multiple viable compounds within the family. Alternatively, the customer may submit a specific chemical structure.

As shown in FIG. 5, the chemical contracting process is seamlessly linked to a chemical synthesis strategy that is derived from a chemical reaction database. In step 300, the customer initially specifies synthesis requirements for any desired chemical or chemical family to the intermediary system central computer. In step 302, the intermediary system central computer stores the chemical or chemical family submitted by the customer, and generates preferred synthesis strategies using the chemical reaction database. Next, in step 304, the intermediary system central computer generates a set of synthesis factors based on an established set of guidelines in order to provide an efficient bidding process. During step 306, a database of known suppliers is accessed, and each known supplier is scored based on a weighting algorithm that accounts for each of the factors generated by the intermediary system central computer. The weighting algorithm next certifies eligible suppliers for bidding on the synthesis requirements in step 308. Preferably, the chemical structure and synthesis strategies for custom chemical synthesis are released to eligible suppliers in step 310 using the internet. Eligible suppliers are then allowed to place a bid for the custom chemical synthesis with the intermediary system central computer in step 312. Once bids have been collected by the intermediary system central computer over an allowable period of time, the intermediary system central computer evaluates the bids and supplies the customer with a list of best fit bids in step 314. Again, as described above, the best fit bids become a means for identifying appropriate, qualified suppliers for the synthesis. In step 316, the customer indicates to the intermediary system central computer whether a bid will be accepted, and in step 318, a binding contract is established if the customer has accepted a particular bid. Alternatively, the intermediary system central computer may release the name of the chosen supplier to the customer, and the name of the customer to the chosen supplier.

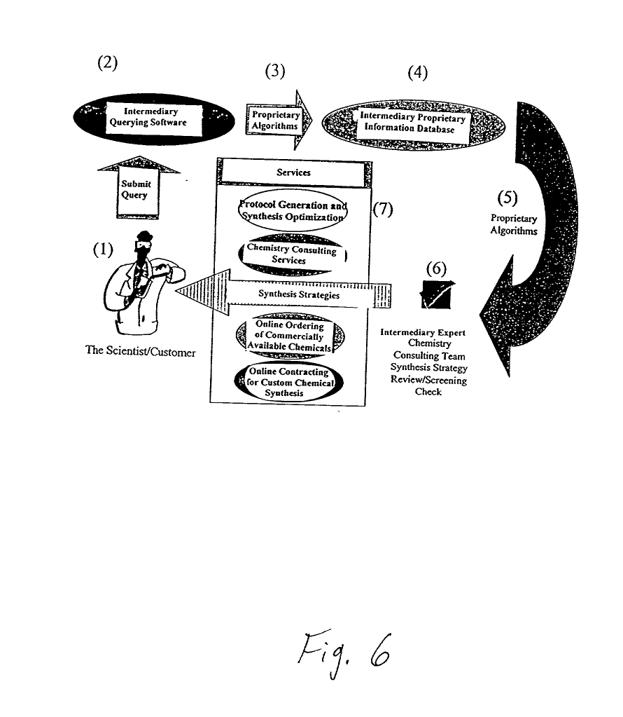

As shown in FIG. 6, the present development provides an intelligent internet-based system through which information, consulting and outsourcing services for chemical synthesis can be provided. By utilizing a web site, customers can submit requests for synthetic strategies to make a specific drug or chemical. In response to a customer request, the intelligent system will return a list of economically efficient and potentially novel chemical synthesis strategies. The customer can subsequently rank synthetic approaches based on parameters such as yield, cost, or number of synthesis steps.

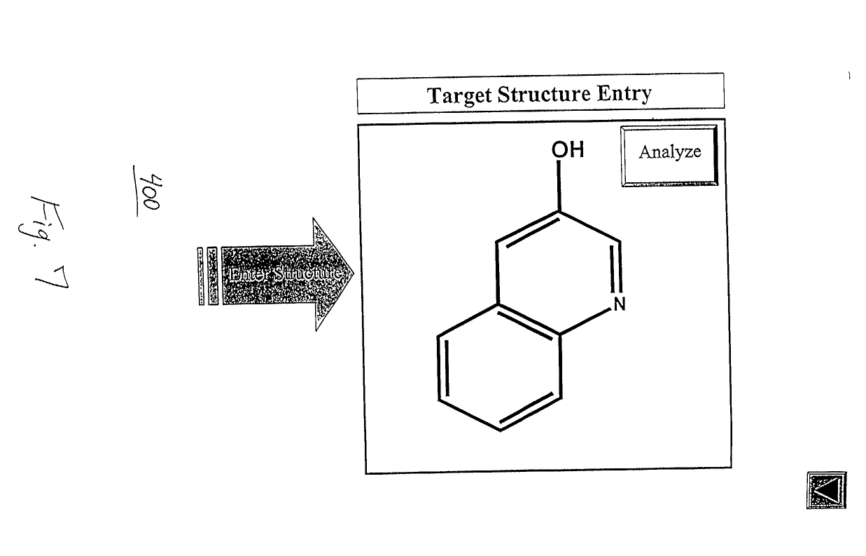

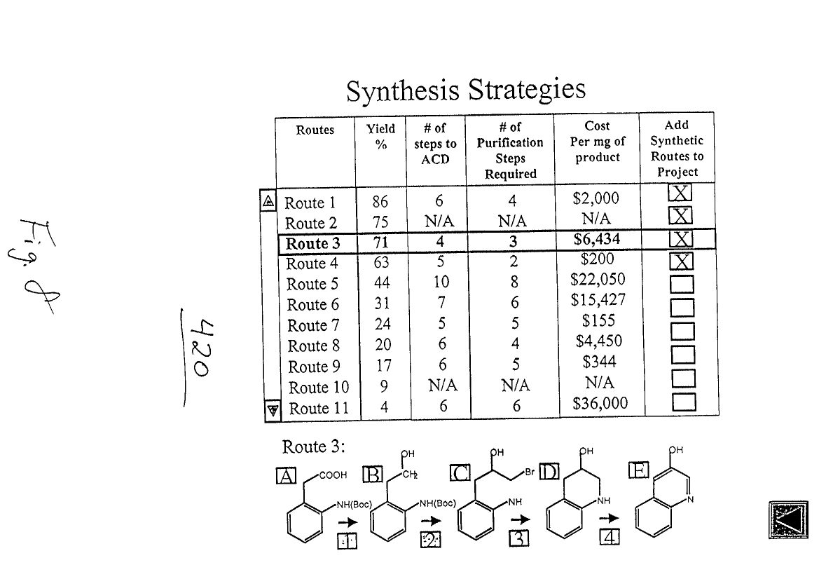

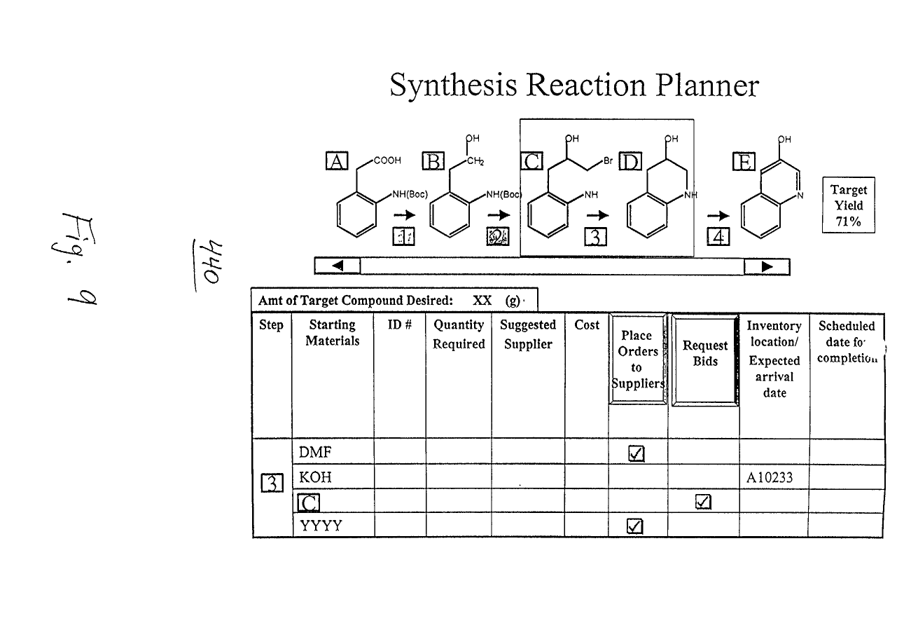

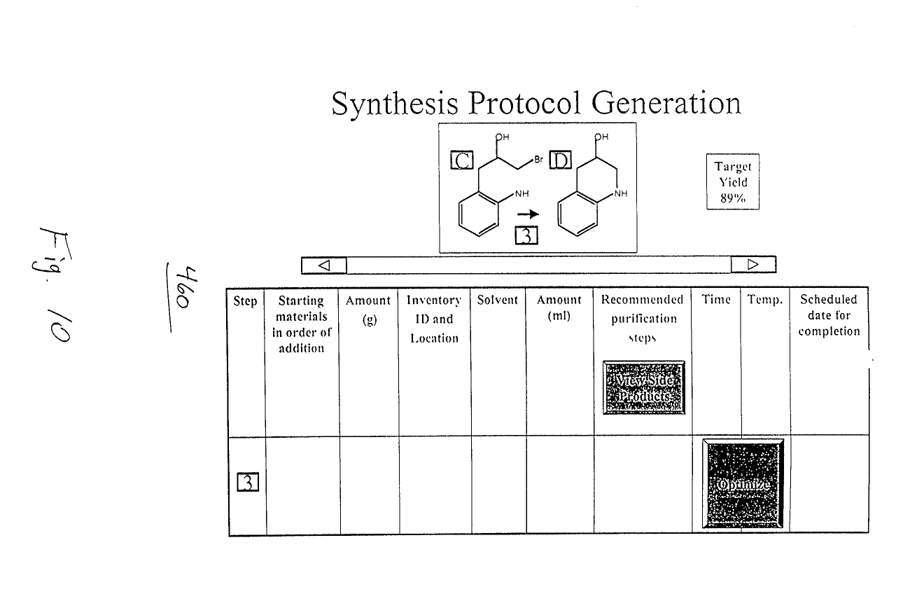

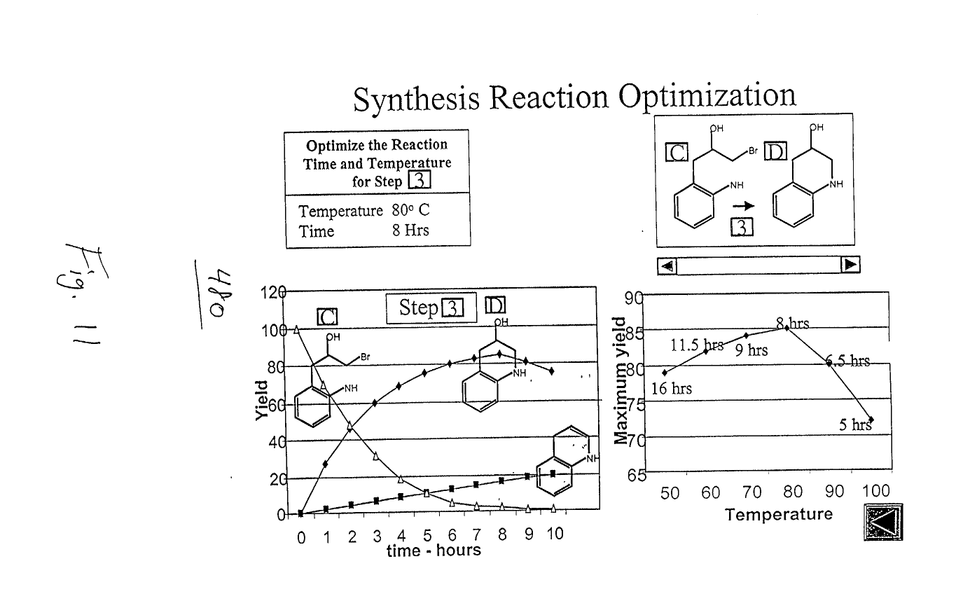

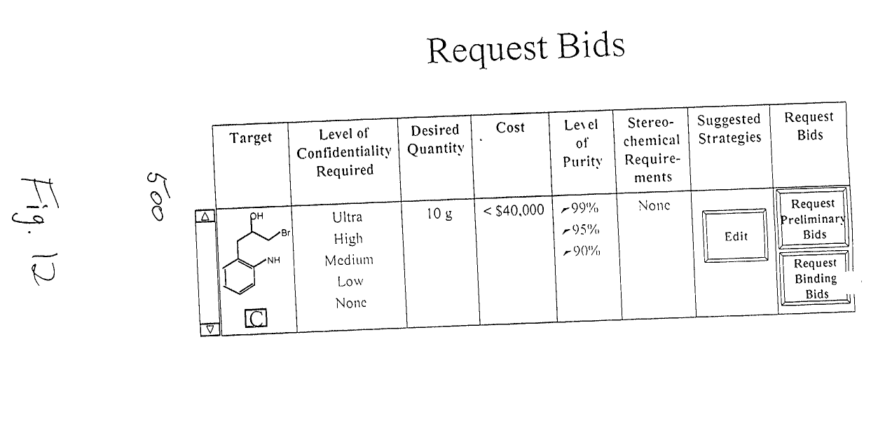

As shown in FIGS. 7-12, the present development may be implemented using the following preferred sequence of events. First, as shown on display screen 400, a target structure is entered into the intermediary system central computer. In this example, the target structure is 4 Quinolin H one. Second, as shown on display screen 420, a series of synthesis routes or strategies are generated by the intermediary system central computer. Variables predicted for each synthesis route identified by the intermediary system central computer may include, but are not limited to, the yield %, the number of steps to commercially available starting materials, the number of purification steps required, and the cost per milligram of product. Individual routes may be selected manually by the customer or an expert if they conform to the customer's requirements, or they may be selected automatically by the intermediary system central computer. In addition, the chemistry steps required for each synthesis route may be displayed. Third, as shown on display screen 440, a synthesis reaction planner routine is engaged, which analyzes each chemistry step in a given synthesis job. An amount of the target compound to be synthesized may be specified, and each step in the reaction sequence may be individually listed for inspection by the customer, an expert, or the intermediary system central computer. Among the listings available for each synthesis step are the name of the reaction material, an identification number, the quantity required, a suggested supplier, and cost. In addition, for each starting material, the customer, expert, or intermediary system central computer may indicate whether an order should be placed with a supplier, or whether a request for bids should be issued for a material that is unavailable commercially. An inventory location and expected arrival date may be obtained, as well as a scheduled date for completion, depending on the databases integrated with the intermediary system central computer.

The next step, as shown on display screen 460, event is the synthesis protocol generation. For each reaction or target material, the following information may be generated: starting materials in order of addition, amount (in grams or other appropriate units), inventory identification and location information, solvent, amount (in milliliters or other appropriate units), recommended purification steps, time, temperature, and scheduled date for completion. For the recommended purification steps, side products may also be viewed selectively. Also, the time and temperature for the synthesis may be selectively optimized, through application of protocols based on experimental data, modeling, or other information. Preferably, the optimization routine employed for optimizing the synthesis reaction produces data, as shown on display screen 480, that shows yield as a function of time (in hours, or other appropriate units), as well as maximum yield as a function of temperature.

Next, after selection of a target material, as shown on display screen 500, a request for bids may be released to suppliers. The request may be in the form that indicates the structure of the target material, the level of confidence required (such as ultra, high, medium, low, and none), the desired quantity (in grams, or other appropriate units), the maximum cost for the custom synthesis, the level of purity required, and stereochemical requirements (if any). Suggested strategies may also be provided to the suppliers, and these strategies may be selectively edited prior to release. Preferably, two forms of release of the request for bids are available, including a Request for Preliminary Bids and a Request for Binding Bids. The remainder of the bidding process, and the best-fit analysis, follows the steps discussed above with respect to other embodiments of the present invention. The intermediary system central computer may control all, or only some of the steps in the aforementioned sequence, so that control can be distributed among customers, the intermediary system central computer, and even suppliers.

The present invention is also directed to a computer-based bidding system that allows groups of customers or buyers to pool their individual interests in the custom synthesis of a chemical, and together agree to seek a supplier to synthesize the chemical. The pooling of interests may also be directed to the pooling of interests for the synthesis of a chemical using a particular synthesis strategy. Such a pooling of intents to purchase can result in a single request for quotations, and this request will thus cover a larger quantity for synthesis and purchase than the quantity required by any one customer in the pool. Preferably, the aforementioned embodiments are modified to accommodate such a pooling of interests by including a step at any time prior to the release of the chemical structure to eligible suppliers. However, the pooling of interests step may occur at any time prior to establishing the binding contract between a customer and a supplier. Alternatively, the binding contract may contain a provision permitting modification if multiple customers become interested in pooling.

The present invention is also directed to a computer-based bidding system that allows groups of customers or buyers to pool their individual interests in the custom synthesis of a chemical for which more than one synthesis strategy is predicted or known, yet the probability that each strategy will produce the chemical to all of the customer's specifications is less than one-hundred percent. Thus, since each strategy for synthesizing a chemical may have a different likelihood of success in meeting all of a customer's specifications, two or more customer's with similar interests in a chemical may pool their interests in determining the effectiveness of the multiple strategies. In a preferred embodiment, all strategies may be attempted, and the results reported, or instead the customers may together submit a request for quotation that specifies that only a particular number of successful synthesis strategies should be confirmed. In this case, whether a strategy is a “successful” strategy may be determined based on mutually agreed upon specifications of the customers. Such a pooling of intents to identify synthesis strategies that meet particular specifications can result in a single request for quotations. Preferably, the aforementioned embodiments are modified to accommodate such a pooling of interests by including a step at any time prior to the release of the potential synthesis strategies to eligible suppliers. An additional round of bidding may later be commenced by individual customers, or groups of customers, related to the use of a specific synthesis strategy identified in the first round of bidding, for producing a particular chemical.

The system of the present invention is intelligent, in part, because of its connection to a proprietary chemical reaction database, which may be experimentally generated. Such a database is capable of supplying a tremendous breadth of chemical-related information, due to the database's information content, size, and consistency and reliability. In addition, as more customers use the database and as additional reactions are added to the database, the coverage and thus the usefulness of the database will increase.

To ensure the reliability and consistency of the database-generated strategies, a team of expert chemists may also be employed to evaluate and filter the database-generated strategies before they are returned to the customer. The experts therefore provide quality control for the strategies identified through the database, screening the strategies from the database before they are presented to the customer. The team of experts/consultants provide additional chemistry knowledge, and may confirm possible strategies with published information to add information and check for consistency.

Alternatively, for database content that is classified as having a high level of confidence, for example because of consistency with previously observed chemistry (for example, in the chemical literature), customers may also have the option to query the database directly, and obtain responses in real-time. Customers may thus evaluate strategies without intervention of an expert chemistry team.

Based upon strategies that are derived from the various available and integrated databases, including reaction databases, bibliographic or experimental results databases, and databases containing data derived from simulations or other computational approaches, along with input provided by one or more experts, it may be determined that the strategies employ commercially available chemicals. This may additionally be verified using chemical source databases. If the custom chemical synthesis strategy employs commercially available chemicals, the intermediary system central computer may be integrated to allow ordering of the commercially available chemicals that are used in the strategy. Thus, it is also contemplated that this intermediary system will be linked to computer systems and/or databases at commercial suppliers so that inventories, delivery dates, and other relevant factors can be seamlessly accessible, thereby permitting rapid ordering of particular commercially available, or off-the-shelf types of chemicals.

Customers may implement the synthesis strategies identified using the chemical reaction database by outsourcing the synthesis to custom contractors or purchasing the necessary commercially available starting materials. For custom outsourcing projects, a network of custom suppliers may be compiled, with the suppliers linked via the Internet through an intermediary system central computer. After receiving a request for bids from the intermediary system central computer, suppliers may place a bid through the intermediary system central computer, which may then process the bids while maintaining the anonymity of the customer. This assures a high degree of confidentiality, so that only one supplier may eventually be informed of the identity of the customer.

There is a significant need in the marketplace for obtaining and/or outsourcing more efficient, novel and implementable chemical synthesis strategies that have a high likelihood of success and a short implementation time. This type of information is not commercially available and would address a major bottleneck in drug and chemical R&D.

A chemical reaction database can provide customers with more efficient, novel and comprehensive chemical synthesis strategies that have a much higher likelihood of success, have a shorter implementation time, and cost less than current approaches.

There is unquestionably a need for this type of system, as outsourcing of chemical synthesis is a significant part of the fine and specialty chemicals industry ($25 billion US, $60 billion worldwide) with high growth potential (forecasted at ˜10% annually). Specifically, the existing outsourcing systems are inefficient due to: fragmentation of the supplier base; encumbered relationships (royalties and other shared-risk arrangements) that are not in the buyer's best interest; lack of direct access to non-chemists (biologists and biochemists); practical limits on the number of suppliers accessible to customers; the fact that suppliers tend to specialize in limited areas of chemical synthesis, and vary widely in pricing, performance and reliability; limited capacity of providers to design creative synthetic pathways; and the fact that customers develop relationships with selected suppliers, and are reluctant to extend their supplier base because of concerns about confidentiality, reliability, and timeliness.

Customers want full ownership of compounds without having to accept a shared-risk relationship (agreements that include royalties and/or milestone payments based on performance). In addition, outsourcing requires validated strategies or strategies that have a reasonable likelihood of success. Therefore, unless the synthesis strategies are found in the literature, they must be tested first, often obviating the need to outsource. Also, ownership of synthesis protocols is key to controlling the process.

Outsourcing plays distinct but interdependent roles throughout the drug and chemical research and development process. The areas of application are: discovery and development of new compounds, re-synthesis of existing compounds, new synthesis approaches for commercially available compounds, and legal protection strategies.

Discovery and development of new pharmaceutical or agrochemical compounds may proceed through three stages . In stage I (early discovery), the objective is to determine biological activity, with the chemicals typically in milligram quantities. There must be low cost, and reasonable purity. In stage II (late discovery), the objective is to determine Structure Activity Relationships, and obtain broad patent protection. Typically, the chemicals are needed in gram quantities, and the process involves creative chemical design with low cost. Finally, in stage III (development), the objective is compliance with cost and regulatory requirements, production at the kilogram level, with concomitant requirements for cost-effective scale-up and FDA compliance.

Among the business strategies employable using the present development is the re-synthesis of existing compounds. This covers contract synthesis of compounds for which there are validated synthetic strategies that are not commercially available. Another approach is the synthesis of commercial compounds using novel strategies. Generic producers, for example, have an interest in developing chemical synthesis strategies for existing commercial compounds. These strategies can be developed during the term of the patent protection in preparation for generic production at the end of the patent protection term. In addition, legal protections, such as provided by patents, can often be bypassed by synthesizing compounds with similar biological activity that have not been claimed in the original art. An exhaustive search for synthesis paths that lead to analogs with similar activity may lead to a more effective patent coverage. The present development also allows patent databases to be integrated with the intermediary system central computer to search for any patent protection already in force for synthesis strategies identified by either the intermediary system central computer or the customer. In the event that patent protection has not already been obtained for a particular synthesis method, for example, the intermediary system central computer may identify the method to the customer as including potentially patentable subject matter. A customer may also make use of the intermediary system central computer in order to bypass a competitor's patent, by using the intermediary system central computer to design or identify novel synthesis strategies.

The goals of the present development are:

(1) to provide the first and leading intelligent Internet based system for chemical synthesis;

(2) to use the power of the Internet to operate a worldwide network of chemical synthesis suppliers;

(3) to develop a intermediary-centric and buyer-centric model by which the intermediary adds value to the process by providing unique cheminformatics capabilities and dealing with providers on behalf of customers;

(4) to enable non-chemists to access a virtual chemical synthesis lab; and

(5) to structure the flow of information so as to enhance the value of the intermediary's proprietary chemical synthesis database.

The following are some of the products envisioned as being possible with the present development:

(1) software generated synthesis strategies for discrete compounds;

(2) consulting based synthesis strategies for discrete compounds;

(3) outsourcing synthesis: customers in need of one or a few compounds will place an order with the intermediary, which will use its Chemical Strategies Team to design the best synthetic strategies, and will also offer the option to solicit bids from its network of contract synthesis providers;

(4) software generated library design: customers in need of global or focused libraries will formulate the appropriate query to the intermediary, which the intermediary will then return the library design with the corresponding synthesis strategies, offering also outsourcing services;

(5) consulting based library design: customers in need of global or focused libraries will formulate the appropriate query to the intermediary, which will then return the library design with the corresponding synthesis strategies, offering also outsourcing services;

(6) legal-related services: companies filing composition of matter patents, or wishing to bypass existing patents, will hire the intermediary to design chemical strategies and outsource the synthesis of compounds for biological testing.

The customer may own all rights to the synthesis protocols, and the transactions may be anonymous.

The outsourcing contracts may assume three preferred formats:

(1) Umbrella cooperation agreements under which a pharmaceutical or chemical company pays a preset fee to have access, on a stand-by basis to the development resources of a vendor. The vendor pledges to maintain a pre-agreed number of man-years. The vendor thus becomes an extension of in-house operations.

(2) Fee-for-service contracts in which a pharmaceutical company grants specific projects to a vendor, whose services are typically priced on a cost-plus basis that reflects the level of manpower and effort incurred. Fees in the range of $100 to $200 per hour or about $150,000 to $300,000 per man-year are typical in the industry.

(3) Success-fee agreements, used mainly by boutiques engaged in the development of second-generation processes. Under such contracts, the vendor's profits are tied to the success of the project.

In order to implement the present development, several steps may be undertaken. First, the intermediary may form an in-house Chemical Strategies Team comprised of chemists who are highly trained in chemical synthesis. This Team will have the following mission: to analyze and interpret results from the internal database experiment; to utilize proprietary algorithms and databases to provide customers with all possible approaches to making the compound; and to process customer queries using all information available (e.g. including literature), making sure that they are consistent with the data contained in these databases as well as their experience. The Team will support what is initially a query-based system moderated by humans.

Second, the possibility of placing chemists at the provider's sites to produce the milligram to gram amounts of compound that most chemistry labs are reluctant to supply should be considered. This placement would be negotiated at a discount over current pricing. Until the deal flow exceeds capacity, this network would be used to supply the intermediary with the functional groups needed for its database.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method for managing contract bidding of chemical synthesis on a computer network, the method comprising the steps of:
receiving a customer's request for quotation for synthesis of a chemical structure;
evaluating potential suppliers based upon at least one factor provided by the customer;
identifying eligible suppliers for bidding on the synthesis;
releasing the request for quotation to eligible suppliers;
receiving bids from eligible suppliers;
evaluating the bids and providing the customer with a list of qualified suppliers; and
receiving a customer's choice of qualified supplier for the synthesis.

2. The method of claim 1, wherein the at least one factor is selected from delivery timing, cost, product yield, level of confidentiality, level of quality control, purity, stereochemical requirements, and synthesis reaction steps.

3. The method of claim 2, wherein the synthesis reaction steps include at least one synthesis route.

4. The method of claim 3, wherein the synthesis route is determined with at least one route factor selected from yield percent, number of steps to commercially available starting materials, number of purification steps, and cost per unit mass of product.

5. The method of claim 1, wherein the list of qualified suppliers is generated by weighting the at least one factor and obtaining a best fit to sets of qualifications of the potential suppliers.

6. The method of claim 5, wherein the sets of qualifications of the potential suppliers include at least one of delivery timing, cost, product yield, level of confidentiality, level of quality control, purity, stereochemical requirements, and synthesis reaction steps.

7. The method of claim 1, wherein the releasing step occurs over the internet.

8. The method of claim 1, further including the step of establishing a binding contract between the customer and the customer's choice of qualified supplier.

9. The method of claim 1, wherein the chemical structure is a family of compounds.

10. A computerized system for managing contract bidding of chemical synthesis on a communications or computer network, the system including means for processing requests for proposals for synthesis of a chemical structure, means for weighting synthesis factors supplied by a customer, means for identifying potential suppliers, means for distributing the requests for proposals and soliciting bids on each request for proposals, and means for identifying appropriate suppliers for the synthesis.
